(19) United States
(12) Patent Application Publication
(10) Pub. No.: US 2010/0036777 A1
(43) Pub. Date: Feb. 11, 2010

(54) Method and system for postal payments and addressing

(75) Inventor: Jason Alexander Korosec, San Jose, CA (US)

Correspondence Address: SCHWEGMAN, LUNDBERG & WOESSNER, P.A., P.O. BOX 2938, MINNEAPOLIS, MN, 55402, US

(73) Assignee: eBay Inc., San Jose, CA (US)

(21) Appl. No.: 12/188,084

(22) Filed: Aug. 7, 2008

(51) Int. Cl. G06F 17/00; G07B 17/02

(52) U.S. Cl. 705/408; 705/410; 705/409

(57) ABSTRACT

Methods and systems for postal payments and addressing are described. In one embodiment, an electronic communication identifier associated with a postal item may be accessed for automated payment. Source user data associated with the postal item may be accessed. A user associated with an electronic communication associated may be identified. Information from the identification of the user may be utilized for addressing or otherwise delivering the postal item, or for securing a payment approval, or for otherwise verifying previous blanket approval for payments.

### BACKGROUND

A postal item is typically affixed with postage to pay for the cost of transport from a source user to a recipient. The address of the recipient is read from the postal item by a postal item processor to determine where to deliver the postal item. The address of the source user may be read by the recipient to identify a source of the postal item and/or by the postal item processor to determine to whom an undeliverable postal item should be returned.

### BRIEF DESCRIPTION OF THE DRAWINGS

Some embodiments are illustrated by way of example and not limitation in the figures of the accompanying drawings in which:

FIG. 1 is a block diagram of a system, according to example embodiments;

FIG. 2 is a block diagram of an example verification subsystem that may be deployed within the system of FIG. 1 according to an example embodiment;

FIG. 3 is a block diagram of an example processing subsystem that may be deployed within the system of FIG. 1 according to an example embodiment;

FIGS. 4 and 5 are flowcharts illustrating a method for user verification according to an example embodiment;

FIGS. 6-11 are flowcharts illustrating a method for postal item processing according to an example embodiment;

FIG. 12 is a flowchart illustrating a method for user verification according to an example embodiment;

FIG. 13 is a flowchart illustrating a method for postal item processing according to an example embodiment;

FIG. 14 is a flowchart illustrating a method for postal item writing according to an example embodiment;

FIG. 15 is a flowchart illustrating a method for data providing according to an example embodiment;

FIGS. 16 and 17 are illustrations of example postal items according to an example embodiment;

FIG. 18 is a network diagram depicting a network system, according to one embodiment, having a client server architecture configured for exchanging data over a network;

FIG. 19 is a block diagram illustrating an example embodiment of multiple network and marketplace applications, which are provided as part of the network-based marketplace;

FIG. 20 is a block diagram diagrammatic representation of machine in the example form of a computer system within which a set of instructions for causing the machine to perform any one or more of the methodologies discussed herein may be executed; and

FIG. 20 is a flowchart illustrating a method for postal item processing according to an example embodiment.

### DETAILED DESCRIPTION

Example methods and systems for postal payments and addressing are described. In the following description, for purposes of explanation, numerous specific details are set forth in order to provide a thorough understanding of example embodiments. It will be evident, however, to one skilled in the art that embodiment of the present invention may be practiced without these specific details.

In an example embodiment, an electronic communication identifier associated with a postal item may be accessed. Source user data associated with the postal item may be accessed. A user associated with the electronic communication identifier may be identified. Verification that the user is associated with the source user data may be made. A confirmation of verification may be provided.

In an example embodiment, an electronic communication identifier associated with a postal item may be accessed. Source user data associated with the postal item may be accessed. A user associated with the electronic communication identifier may be identified. Verification that the user is associated with the source user data may be made. The postal item may be processed for delivery based on verification of the user.

In an example embodiment, an electronic communication identifier may be provided for writing on a postal item. The electronic communication identifier may be associated with a user. Source user data may be provided for writing on the postal item. The source user data may be associated with the user. Recipient data may be provided for writing on the postal item. The postal item may be capable of being provided to a recipient associated with the recipient data after writing of the electronic communication identifier, the source user data, and the recipient data on the postal item.

In an example embodiment, an electronic communication identifier associated with a postal item may be accessed. A user associated with the electronic communication identifier may be identified. Authorization of the user for use of the electronic communication identifier for postal item utilization may be verified. A confirmation of verification may be provided.

In an example embodiment, an electronic communication identifier associated with a postal item may be accessed. A user associated with the electronic communication identifier may be identified. Authorization of the user for use of the electronic communication identifier for postal item utilization may be verified. The postal item may be processed for delivery based on verification of the authorization.

In an example embodiment, an electronic communication identifier associated with a postal item may be automatically determined. A postal charge due for delivery of the postal item by a postal item processor may be determined. A payment request for the postal charge may be communicated to a payment provider. The electronic communication identifier may be associated with an account of a user accessible by the payment provider. The payment request may include the electronic communication identifier.

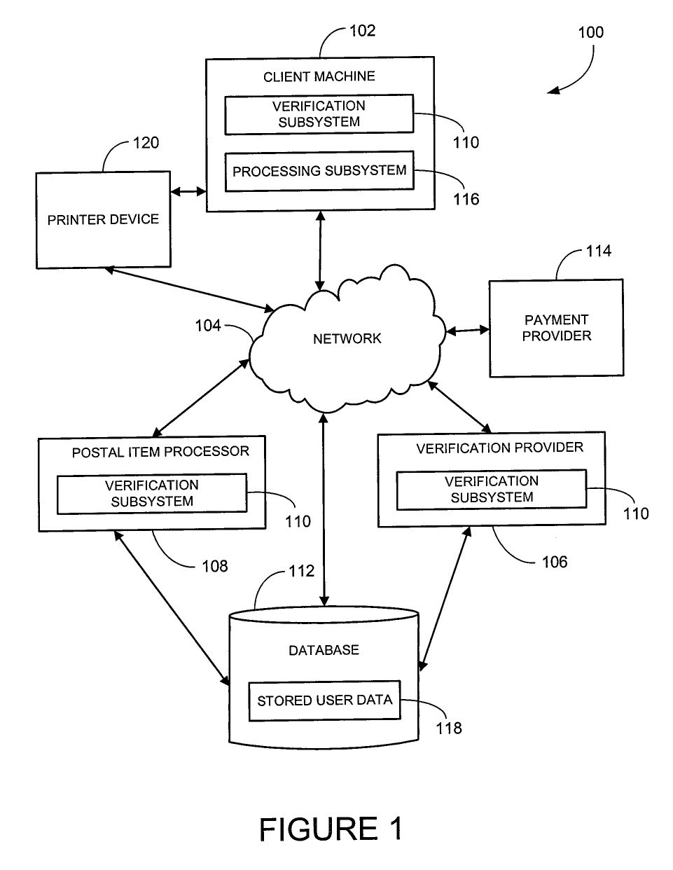

FIG. 1 illustrates an example system 100 in which a client machine 102 may be in communication with a verification provider 106 and/or a postal item processor 108 over a network 104. A user operating the client machine 102 may communicate with the verification provider 106 and/or the postal item processor 108 to enable postal item utilization (e.g., sending and/or receiving a postal item). The postal item may be a post card, a letter, a telegram, a package, overnight mail, or another item sent by or through the post or a shipping company.

Examples of the client machine 102 include a mail scanning device, a set-top box (STB), a receiver card, a mobile telephone, a personal digital assistant (PDA), a display device, a portable gaming unit, and a computing system; however other devices may also be used.

The network 104 over which the client machine 102, the verification provider 106 and/or the postal item processor 108 are in communication may include a Global System for Mobile Communications (GSM) network, an Internet Protocol (IP) network, a Wireless Application Protocol (WAP) network, a WiFi network, or a IEEE 802.11 standards network as well as various combinations thereof. Other conventional and/or later developed wired and wireless networks may also be used.

The verification provider 106 may be used to verify information on the postal item. A resulting confirmation of verification may be provided by the verification provider 106 to the client machine 102, the postal item processor 108, or may be otherwise used.

The postal item processor 108 may be used to process a postal item for shipping. The postal item processor 108 may be operated by or on behalf of a post or a shipping company (e.g., the ROYAL MAIL) to enable sending and receiving of postal items. The verification of data on the postal item may be performed on the postal item processor 108 or received from the client machine 102 or the verification provider 106.

The verification provider 106 and/or the postal item processor 108 may be in communication with a database 112. The database 112 stores user data 118 which may include information regarding users of the verification provider 106 and/or the postal item processor 108.

A verification subsystem 110 may be deployed in the client machine 102, the verification provider 106 and/or the postal item processor 108 to verify that a user is associated with the source user data and process the postal item for delivery based on verification of the user and/or provide a confirmation of verification. For example, the verification provider 110 may provide a confirmation of verification to the client machine 102 and/or the client machine 102, and/or the postal item processor 108 may process the postal item for delivery after verifying the user or receiving a confirmation of verification from the verification provider 106.

A processing subsystem 116 may be deployed in the client machine 102 to verify that a user is associated with source user data and an electronic communication identifier and provide an electronic communication identifier, source user data, and recipient data for writing on a postal item. The electronic communication identifier, source user data, and recipient data may be provided to a printing device 120 for writing on a postal item, or the functionality of the printing device 120 may be incorporated in the client machine 102.

A payment provider 114 may receive a payment request and provide confirmation of payment to the client machine 102, the verification provider 106, and/or the postal item processor 108. The payment provider may also receive and provide payments. The payment provider 114 may be, by way of example, PAYPAL by eBay, Inc. of San Jose, Calif. However, other payment providers may also be used.

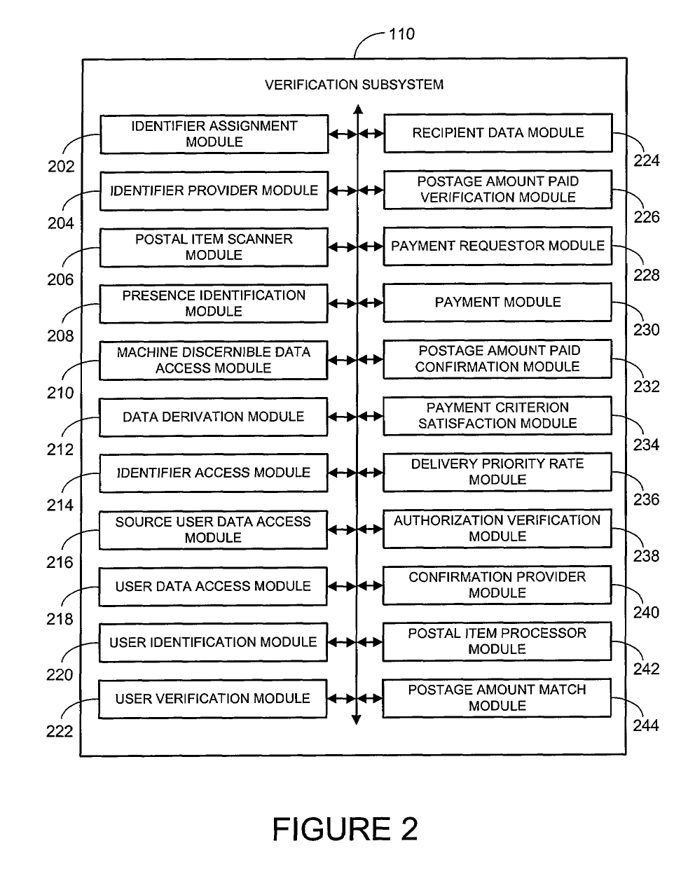

FIG. 2 illustrates an example verification subsystem 110 that may be deployed in the client machine 102, the verification provider 106, and/or the postal item processor 108 of the system 100 (see FIG. 1) or otherwise deployed in another system. The verification subsystem 110 may include an identifier assignment module 202, an identifier provider module 204, a postal item scanner module 206, a presence identification module 208, an machine discernable data access module 210, a data derivation module 212, an identifier access module 214, a source user data access module 216, a user data access module 218, a user identification module 220, a user verification module 222, a recipient data module 224, a postage amount paid verification module 226, a payment requester module 228, a payment module 230, a postage amount paid confirmation module 232, a payment criterion satisfaction module 234, a delivery priority rate module 236, an authorization verification module 238, a confirmation provider module 240, a postal item processor module 242, and/or a postage amount match module 244. Other modules may also be included.

The identifier assignment module 202 assigns an electronic communication identifier to a user. The electronic communication identifier may be an e-mail address, a mobile phone number, a postal account identifier, or a different identifier that may be used to uniquely identify the user.

The identifier provider module 204 provides the electronic communication identifier to a user. The user may be a real person or an entity. Example entities include for-profit companies, non-profit companies, non-governmental organization (NGOs), governmental agencies, and the like.

The postal item scanner module 206 scans a postal item. The postal item may be a post card, a letter, a telegram, a package, overnight mail, or another item sent by or through the post or a shipping company. The scan may be an optical scan, a radio frequency scan, or a different type of scan to read information from the postal item.

The presence identification module 208 identifies a presence of the electronic communication identifier on the postal item based on the scanning of the postal item. The electronic communication identifier may have been printed directly on the postal item, affixed to the postal item as a sticker, hand-written on the postal item, or otherwise associated with the postal item such that a scanner can identify the presence of the electronic communication identifier on the postal item.

The machine discernable data access module 210 accesses machine discernable data associated with the postal item. The accessing of the electronic communication identifier may be based on identification of the presence of the electronic communication identifier on the postal item. The machine discernable data may be a single dimension bar code, a multidimensional bar code, an encoded pattern, or another electronic representation of data. The machine discernable data may be embedded within a Radio Frequency Identification (RFID) tag or otherwise stored.

The data derivation module 212 derives the electronic communication identifier from the machine discernible data. The identifier access module 214 accesses an electronic communication identifier associated with a postal item. The electronic communication identifier may be derived from the machine discernible data, accessed directly from the postal item, or may be otherwise accessed.

The source user data access module 216 accesses source user data associated with the postal item. The source user data may include, by way of example a source user name, a source user street address, a source user city, a source user state, a source user zip code, a source user country, a source user phone number, a source user e-mail address, or the like. The user data access module 218 accesses the stored user data 118 from the database 112 based on the electronic communication identifier.

The user identification module 220 identifies a user associated with the electronic communication identifier. The identification of the user may be based on the stored user data 118. The user verification module 222 verifies that the user is associated with the source user data. The verification may be based on the stored user data 118.

The recipient data module 224 accesses recipient data from the postal item and verifies the recipient data meets a recipient criterion. The recipient data may include, by way of example, a recipient name, a recipient street address, a recipient city, a recipient state, a recipient zip code, a recipient country, a recipient phone number, a recipient e-mail address, or the like. The recipient criterion may be predefined by a user or otherwise selected. The recipient criterion may include, by way of example, limitations on authorized addressees, addressors, or the like.

The postage amount paid verification module 226 identifies a postage amount paid from the machine discernible data, determines a postage amount due for the postal item, and verifies that the postage amount paid satisfies the postage amount due.

The payment requestor module 228 provides a payment request to the payment provider 114 based on an insufficient amount of the postage amount paid and receives confirmation of payment from the payment provider 114. The providing of the payment request may be based on satisfaction of a payment criterion. The payment request may include an indication as to whether the source user, the recipient, and/or both the source user and the recipient are to make payment.

The payment module 230 provides a payment request to the payment provider 114 based on an insufficient amount of the postage amount paid and receives electronic payment of the insufficient amount from the payment provider 114. The providing of the payment request may be based on satisfaction of a payment criterion. The payment request may include an indication as to whether the source user, the recipient, and/or both the source user and the recipient are to make payment.

The postage amount paid confirmation module 232 determines a postage amount due for the postal item, provides a payment request for the postage amount due to the payment provider 114, and receives confirmation of payment from the payment provider 114 or electronic payment in the postage amount due from the payment provider 114. The providing of the payment request may be based on satisfaction of a payment criterion.

The payment criterion satisfaction module 234 determines whether the postage amount due satisfies a payment criterion associated with the user. The payment criterion may include, by way of example, a payment minimum value, a payment maximum value, a predetermined user, a non-excluded user, an authorized reverse billing sender where the user-addressee pays the postage for the user-sender, or the like.

The delivery priority rate module 236 identifies a delivery priority rate from the machine discernible data and/or determines a delivery priority rate based on the accessing of the electronic communication identifier.

The authorization verification module 238 verifies authorization of the user for use of the electronic communication identifier for postal item utilization.

The confirmation provider module 240 provides a confirmation of verification of the user. The confirmation may be provided based on verification of the user, the recipient data, verification of the postage amount paid, receipt of the electronic payment, identification of the delivery priority rate, determination of the delivery priority rate, verification of authorization, and/or receipt of the confirmation.

The postal item processor module 242 processes the postal item for delivery based on verification of the user, the recipient data, verification of the postage amount paid, receipt of the electronic payment, identification of the delivery priority rate, determination of the delivery priority rate, and/or receipt of the confirmation. The postage amount match module 244 identifies a postage amount from the machine discernible data, verifies the postage amount of the postal item, and provides a postage amount match based on verification of the postage amount.

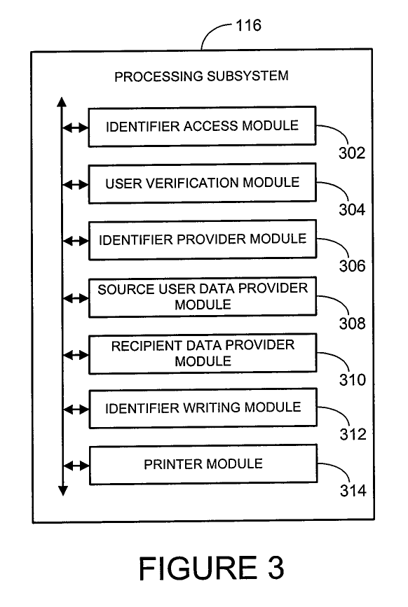

FIG. 3 illustrates an example processing subsystem 116 that may be deployed in the client machine 102 of the system 100 (see FIG. 1) or otherwise deployed in another system. The processing subsystem 116 may include an identifier access module 302, a user verification module 304, an identifier provider module 306, source user data provider module 308, recipient data provider module 310, an identifier writing module 312, and/or a printer module 314. Other modules may also be included.

The identifier access module 302 accesses the electronic communication identifier, the source user data, and the recipient data. The user verification module 304 verifies that the user is associated with the source user data and the electronic communication identifier.

The identifier provider module 306 provides an electronic communication identifier for writing on a postal item. The electronic communication identifier may be associated with a user. The providing of the electronic communication identifier based on verification by the user verification module 304.

The source user data provider module 308 provides source user data for writing on the postal item. The source user data may be associated with the user. The providing of the source user data for writing is based on verification by the user verification module 304.

The recipient data provider module 310 provides recipient data for writing on the postal item. The postal item may be capable of being provided to a recipient associated with the recipient data after the writing of the electronic communication identifier, the source user data, and the recipient data on the postal item.

The identifier writing module 312 writes the electronic communication identifier, the source user data, and the recipient data on the postal item. The printer module 314 provides the electronic communication identifier, the source user data, and the recipient data to the printing device 120.

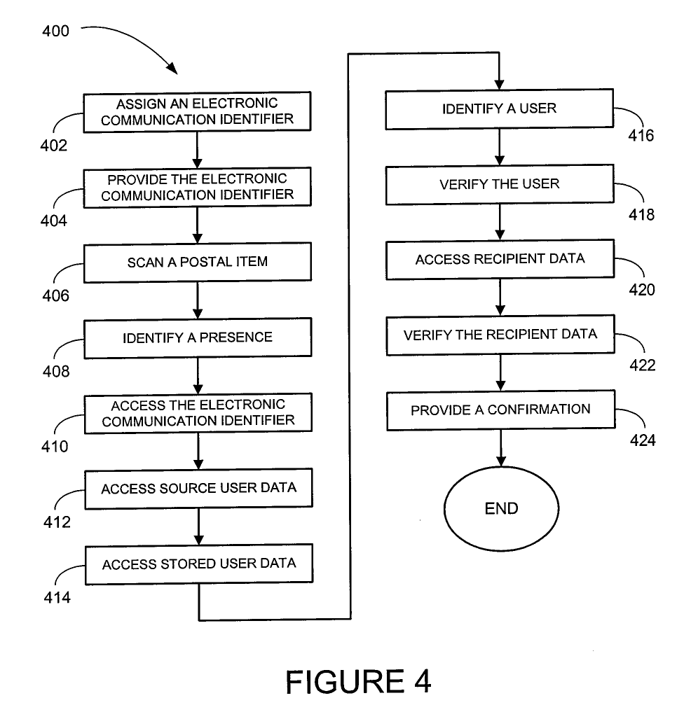

FIG. 4 illustrates a method 400 for user verification according to an example embodiment. The method 400 may be performed by the client machine 102, the verification provider 106, and/or the postal item processor 108 of the system 100 (see FIG. 1) or otherwise performed.

An electronic communication identifier may be assigned to a user at block 402. The electronic communication identifier may be an e-mail address, a mobile phone number, a postal account identifier, or a different identifier that may be used to uniquely identify the user. The user may be a real person or an entity. Example entities include for-profit companies, non-profit companies, NGOs, governmental agencies, and the like.

The electronic communication identifier may be provided to the user at block 404. A postal item may be scanned at block 406. The postal item may be a post card, a letter, a telegram, a package, overnight mail, or another item sent by or through the post or a shipping company.

A presence of the electronic communication identifier on the postal item may be identified at block 408 based on the scanning of the postal item. The electronic communication identifier may have been printed directly on the postal item, affixed to the postal item as a sticker, hand-written on the postal item, or otherwise associated with the postal item such that a scanner can identify the presence of the electronic communication identifier on the postal item.

The electronic communication identifier associated with the postal item is accessed at block 410. The accessing of the electronic communication identifier may be based on identification of the presence. The accessing may include, by way of example, optically detecting the electronic communication identifier from the postal item, detecting a radio frequency associated with the electronic communication identifier from the postal item, and/or receiving the electronic communication identifier from a mail scanner device.

Source user data associated with the postal item is accessed at block 412. The source user data may include, by way of example, a source user name, a source user street address, a source user city, a source user state, a source user zip code, a source user country, a source user phone number, and/or a source user e-mail address.

The stored user data 118 may be accessed from the database 112 at block 414 based on the electronic communication identifier. A user associated with the electronic communication identifier is identified at block 416. The identification of the user may be based on the stored user data 118.

Verification that the user is associated with the source user data is made at block 418. The verification of the user may be based on the stored user data 118.

Recipient data may be accessed from the postal item at block 420. The recipient data may include, by way of example a recipient name, a recipient street address, a recipient city, a recipient state, a recipient zip code, a recipient country, a recipient phone number, a recipient e-mail address, or the like.

Verification that the recipient data meets a recipient criterion may be performed at block 422. A confirmation of verification is provided at block 424 based on verification of the user and/or the recipient data.

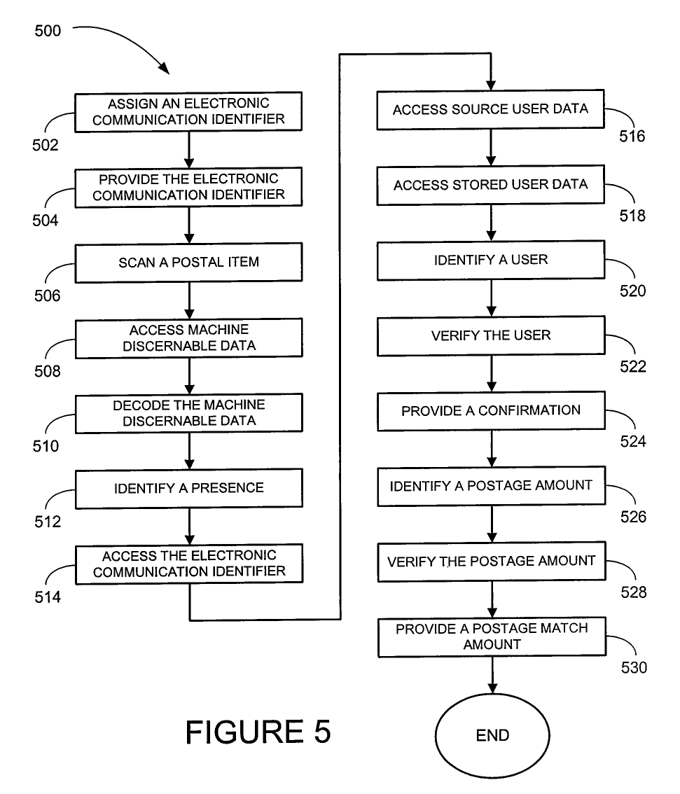

FIG. 5 illustrates a method 500 for user verification according to an example embodiment. The method 500 may be performed by the client machine 102, the verification provider 106, and/or the postal item processor 108 of the system 100 (see FIG. 1) or otherwise performed.

An electronic communication identifier may be assigned to the user at block 502. The electronic communication identifier may be an e-mail address, a mobile phone number, a postal account identifier, or a different identifier that may be used to uniquely identify the user. The user may be a real person or an entity. Example entities include for-profit companies, non-profit companies, NGOs, governmental agencies, and the like. The electronic communication identifier may be provided to the user at block 504.

A postal item may be scanned at block 506. The postal item may be a post card, a letter, a telegram, a package, overnight mail, or another item sent by or through the post or a shipping company.

Machine discernable data associated with the postal item may be accessed at block 508. The Machine discernable data may be a single dimension bar code, a multidimensional bar code, an encoded pattern, or another electronic representation of data. The electronic communication identifier may be derived from the machine discernable data at block 510.

A presence of the electronic communication identifier on the postal item may be identified at block 512 based on the scanning of the postal item. The electronic communication identifier may have been printed directly on the postal item, affixed to the postal item as a sticker, hand-written on the postal item, or otherwise associated with the postal item such that a scanner can identify the presence of the electronic communication identifier on the postal item.

An electronic communication identifier associated with a postal item is accessed at block 514. The accessing of the electronic communication identifier may be based on identification of the presence. The accessing may include, by way of example, optically detecting the electronic communication identifier from the postal item, detecting a radio frequency associated with the electronic communication identifier from the postal item, and/or receiving the electronic communication identifier from a mail scanner device.

Source user data associated with the postal item is accessed at block 516. The stored user data 118 may be accessed from the database 112 at block 518 based on the electronic communication identifier.

A user associated with the electronic communication identifier is identified at block 520. The identification of the user may be based on user data. Verification that the user is associated with the source user data is made at block 522. The verifying of the user may be based on the stored user data 118.

A confirmation of verification is provided at block 524. A postage amount may be identified from the machine discernible data at block 526.

The postage amount of the postal item may be verified at block 528. A postage amount match may be provided at block 530 based on the verifying of the postage amount.

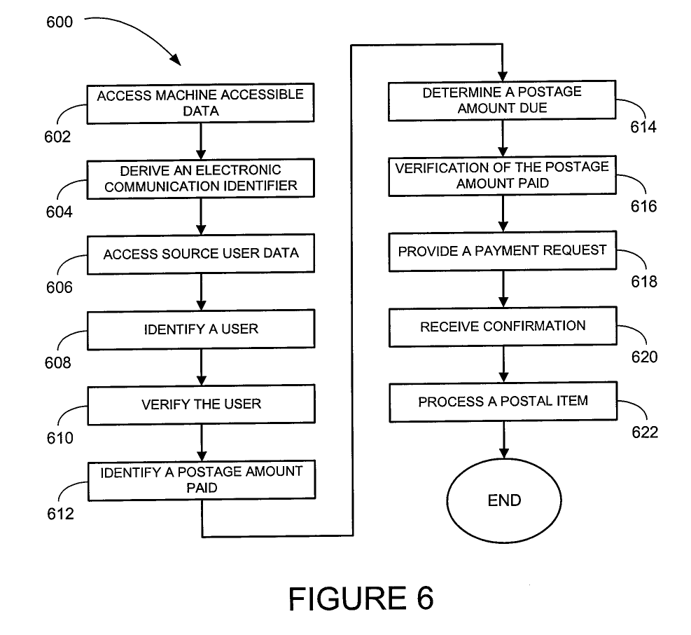

FIG. 6 illustrates a method 600 for postal item processing according to an example embodiment. The method 600 may be performed by the client machine 102, the verification provider 106, and/or the postal item processor 108 of the system 100 (see FIG. 1) or otherwise performed.

Machine discernable data associated with the postal item may be accessed at block 602. An electronic communication identifier may be derived from the machine discernable data at block 604. Source user data associated with the postal item is accessed at block 606.

A user associated with the electronic communication identifier is identified at block 608. Verification is made that the user is associated with the source user data at block 610.

A postage amount paid may be identified from the machine discernible data at block 612. A postage amount due may be determined for the postal item at block 614.

Verification that the postage amount paid satisfies the postage amount due may be made at block 616. At block 618, a payment request may be provided to the payment provider 114 based on an insufficient amount of the postage amount paid. The payment request may include an indication as to whether the source user, the recipient, and/or both the source user and the recipient are to make payment. Confirmation of payment may be received from the payment provider 114 at block 620.

The postal item is processed for delivery based on verification of the user, verification of the postage amount paid, and/or receipt of the confirmation at block 622.

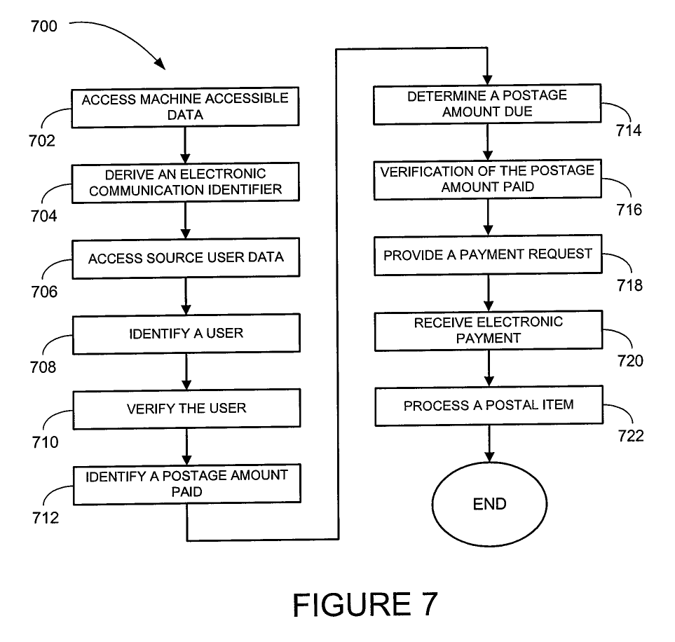

FIG. 7 illustrates a method 700 for postal item processing according to an example embodiment. The method 700 may be performed by the client machine 102, the verification provider 106, and/or the postal item processor 108 of the system 100 (see FIG. 1) or otherwise performed.

Machine discernable data associated with the postal item may be accessed at block 702. An electronic communication identifier may be derived from the machine discernable data at block 704. Source user data associated with the postal item is accessed at block 706.

A user associated with the electronic communication identifier is identified at block 708. Verification is made that the user is associated with the source user data at block 710.

A postage amount paid may be identified from the machine discernible data at block 712. A postage amount due may be determined for the postal item at block 714. Verification that the postage amount paid satisfies the postage amount due may be made at block 716.

At block 718, a payment request may be provided to the payment provider 114 based on an insufficient amount of the postage amount paid. The payment request may include an indication as to whether the source user, the recipient, and/or both the source user and the recipient are to make payment. Electronic payment of the insufficient amount may be received from the payment provider 114 at block 720.

At block 722, the postal item is processed for delivery based on verification of the user, verification of the postage amount paid, and/or receipt of the electronic payment.

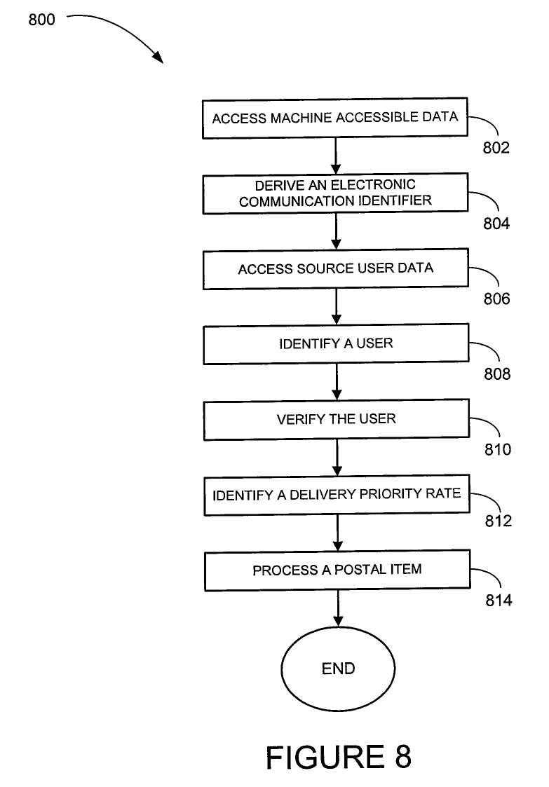

FIG. 8 illustrates a method 800 for postal item processing according to an example embodiment. The method 800 may be performed by the client machine 102, the verification provider 106, and/or the postal item processor 108 of the system 100 (see FIG. 1) or otherwise performed.

Machine discernable data associated with the postal item may be accessed at block 802. An electronic communication identifier may be derived from the machine discernable data at block 804. Source user data associated with the postal item is accessed at block 806.

A user associated with the electronic communication identifier is identified at block 808. Verification is made that the user is associated with the source user data at block 810.

A delivery priority rate may be identified from the machine discernible data at block 812. At block 814, the postal item is processed for delivery based on verification of the user and/or identification of the delivery priority rate.

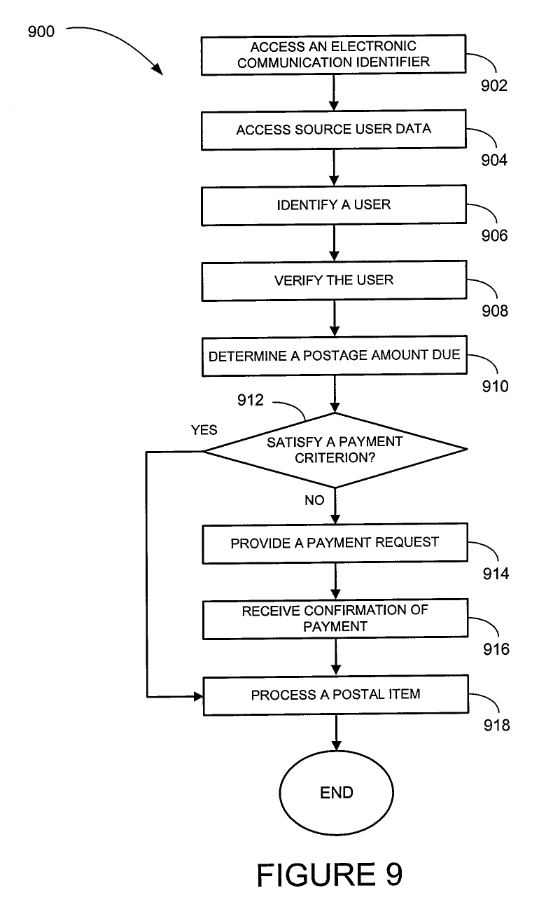

FIG. 9 illustrates a method 900 for postal item processing according to an example embodiment. The method 900 may be performed by the client machine 102, the verification provider 106, and/or the postal item processor 108 of the system 100 (see FIG. 1) or otherwise performed.

An electronic communication identifier associated with a postal item is accessed at block 902. Source user data associated with the postal item is accessed at block 904.

A user associated with the electronic communication identifier is identified at block 906. Verification is made that the user is associated with the source user data at block 908.

A postage amount due may be determined for the postal item at block 910. At decision block 912, a determination of whether the postage amount due satisfies a payment criterion associated with the user may be made. The payment criterion may include, by way of example, a payment minimum value, a payment maximum value, a predetermined user, a non-excluded user, or an authorized reverse billing sender where the user-addressee pays the postage for the user-sender, or the like. Other payment criteria may be used. If a determination is made that the postage amount due satisfies the payment criterion, the method 900 may proceed to block 918. If a determination is made at decision block 912 that the postage due does not satisfy the payment criterion, the method 900 may proceed to block 914.

A payment request for the postage amount due may be provided to the payment provider 114 at block 914. The payment request may include an indication as to whether the source user, the recipient, and/or both the source user and the recipient are to make payment. The providing of the payment request may be based on satisfaction of the payment criterion. Confirmation of payment may be received from the payment provider 114 at block 916.

The postal item is processed for delivery based on verification of the user and/or the receipt of the confirmation at block 918.

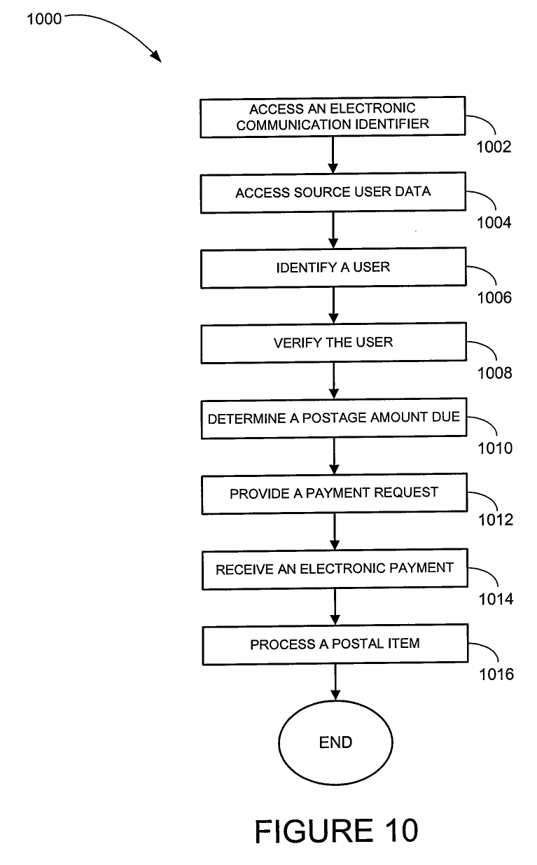

FIG. 10 illustrates a method 1000 for postal item processing according to an example embodiment. The method 1000 may be performed by the client machine 102, the verification provider 106, and/or the postal item processor 108 of the system 100 (see FIG. 1) or otherwise performed.

An electronic communication identifier associated with a postal item is accessed at block 1002. Source user data associated with the postal item is accessed at block 1004.

A user associated with the electronic communication identifier is identified at block 1006. Verification is made that the user is associated with the source user data at block 1008. A postage amount due for the postal item may be determined at block 1010.

A payment request for the postage amount due may be provided to the payment provider 114 at block 1012. The payment request may include an indication as to whether the source user, the recipient, and/or both the source user and the recipient are to make payment. An electronic payment in the postage amount due may be received from the payment provider 114 at block 1014. The postal item is processed for delivery based on verification of the user and/or receipt of the electronic payment at block 1016.

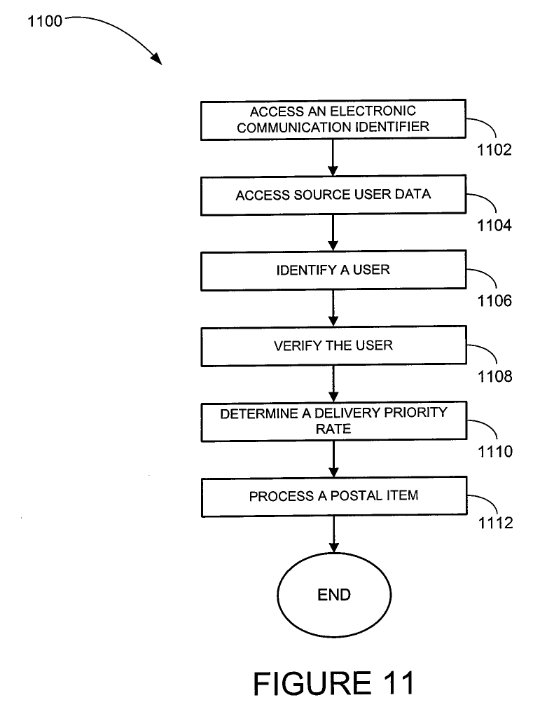

FIG. 11 illustrates a method 1100 for postal item processing according to an example embodiment. The method 1100 may be performed by the client machine 102, the verification provider 106, and/or the postal item processor 108 of the system 100 (see FIG. 1) or otherwise performed.

An electronic communication identifier associated with a postal item is accessed at block 1102. Source user data associated with the postal item is accessed at block 1104.

A user associated with the electronic communication identifier is identified at block 1106. Verification is made that the user is associated with the source user data at block 1108.

At block 1110, a delivery priority rate may be determined based on the accessing of the electronic communication identifier. The postal item is processed for delivery based on verification of the user and/or the delivery priority rate at block 1112.

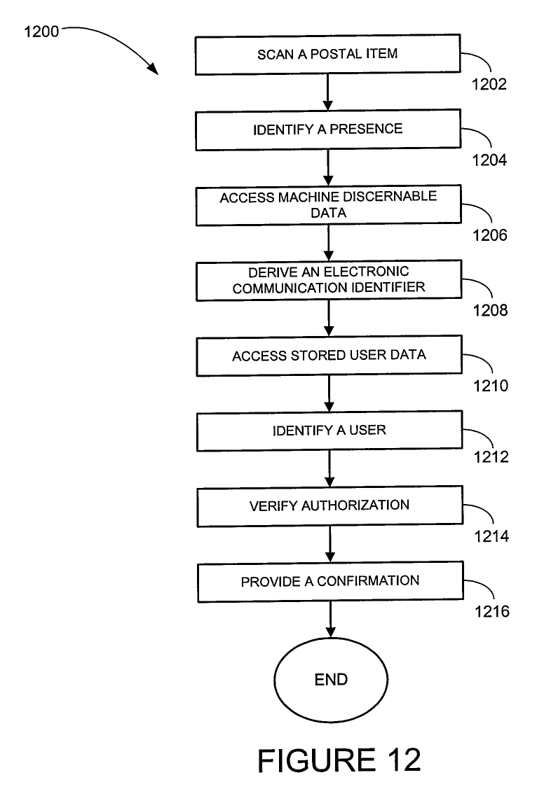

FIG. 12 illustrates a method 1200 for user verification according to an example embodiment. The method 1200 may be performed by the client machine 102, the verification provider 106, and/or the postal item processor 108 of the system 100 (see FIG. 1) or otherwise performed.

The postal item may be scanned at block 1202. A presence of the electronic communication identifier on the postal item may be identified at block 1204 based on the scanning of the postal item.

Machine discernable data associated with the postal item may be accessed at block 1206. The accessing of the electronic communication identifier may be based on identification of the presence. The electronic communication identifier may be derived from the machine discernable data at block 1208. The stored user data 118 may be accessed from the database 112 based on the electronic communication identifier at block 1210.

A user associated with the electronic communication identifier is identified at block 1211. The user may be a source user, a recipient, or both the source user and the recipient. The identification of the user may be based on the stored user data 118. Authorization of the user for use of the electronic communication identifier for postal item utilization is verified at block 1214. The verification of the authorization may be based on the stored user data 118. A confirmation of verification is provided at block 1216.

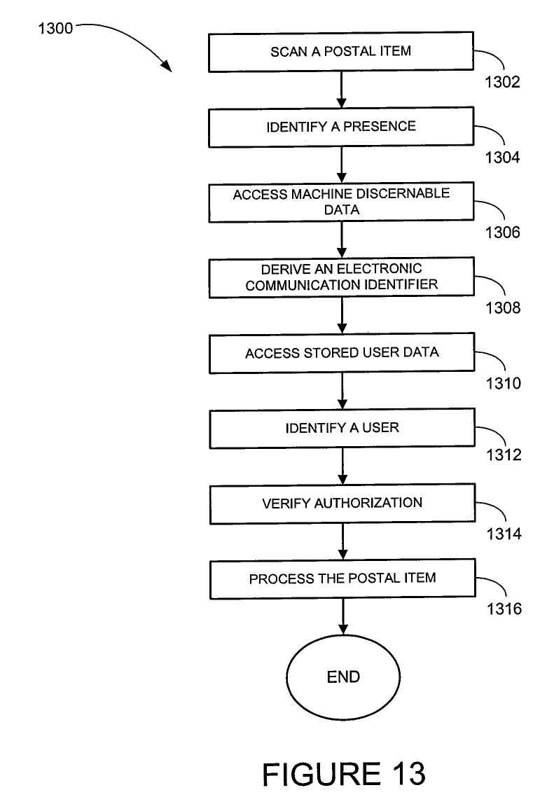

FIG. 13 illustrates a method 1300 for postal item processing according to an example embodiment. The method 1300 may be performed by the client machine 102, the verification provider 106, and/or the postal item processor 108 of the system 100 (see FIG. 1) or otherwise performed.

The postal item may be scanned at block 1302. A presence of the electronic communication identifier on the postal item may be identified at block 1304 based on the scanning of the postal item.

Machine discernable data associated with the postal item may be accessed at block 1306. The accessing of the machine discernable data may be based on identification of the presence. The electronic communication identifier may be derived from the machine discernable data at block 1308. The stored user data 118 may be accessed from the database 112 based on the electronic communication identifier at block 1310.

A user associated with the electronic communication identifier is identified at block 1312. The user may be a source user, a recipient, or both the source user and the recipient. The identification of the user may be based on the stored user data 118. Authorization of the user for use of the electronic communication identifier for postal item utilization is verified at block 1314. The verification of the authorization may be based on the stored user data 118. The postal item may be processed based on verification of the authorization at block 1316.

The methods 400-1300 may be used separately or in combination to utilize postal items. For example, the operations performed at block 420, block 422, block 508, block 510, block 526-block 530, block 612-block 620, block 712-block 720, block 812, decision block 912, block 914, block 916, block 1010-block 1014, and/or block 1110 may be used with the methods 400-1300.

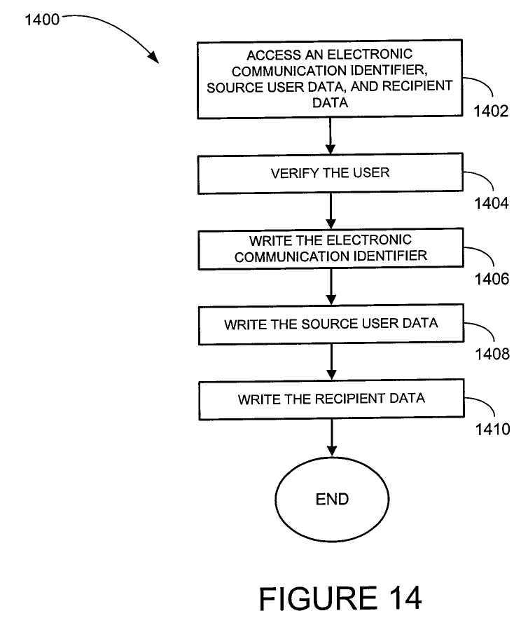

FIG. 14 illustrates a method 1400 for postal item writing according to an example embodiment. The method 1400 may be performed by the client machine 102 of the system 100 (see FIG. 1) or otherwise performed.

The electronic communication identifier, the source user data, and/or the recipient data may be accessed at block 1402. Verification that the user is associated with the source user data and the electronic communication identifier may be made at block 1404.

An electronic communication identifier is written on a postal item at block 1406. The electronic communication identifier may be associated with a user. The providing of the electronic communication identifier may be based on the verification.

Source user data is written on the postal item at block 1408. The source user data may be associated with the user. The providing of the source user data for writing may be based on the verification.

Recipient data is written on the postal item at block 1410. The recipient data may include, by way of example a recipient name, a recipient street address, a recipient city, a recipient state, a recipient zip code, a recipient country, a recipient phone number, a recipient e-mail address, or the like. The postal item may be capable of being provided to a recipient associated with the recipient data after the writing of the electronic communication identifier, the source user data, and the recipient data on the postal item.

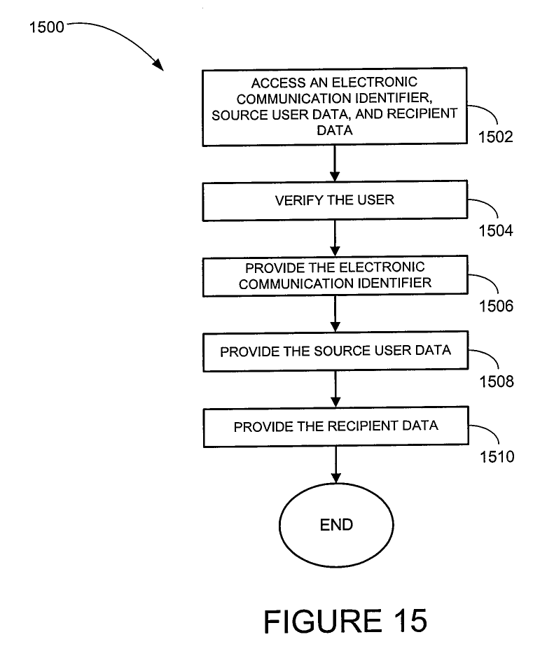

FIG. 15 illustrates a method 1500 for data providing according to an example embodiment. The method 1500 may be performed by the client machine 102 of the system 100 (see FIG. 1) or otherwise performed.

The electronic communication identifier, the source user data, and/or the recipient data may be accessed at block 1502. Verification that the user is associated with the source user data and the electronic communication identifier may be made at block 1504.

An electronic communication identifier is provided to the printing device 118 for writing on a postal item at block 1506. The electronic communication identifier may be associated with a user. The providing of the electronic communication identifier may be based on the verification.

Source user data is provided to the printing device 118 for writing on the postal item at block 1508. The source user data may be associated with the user. The providing of the source user data for writing may be based on the verification.

Recipient data is provided to the printing device 118 for writing on the postal item at block 1510. The postal item may be capable of being provided to a recipient associated with the recipient data after the writing of the electronic communication identifier, the source user data, and the recipient data on the postal item.

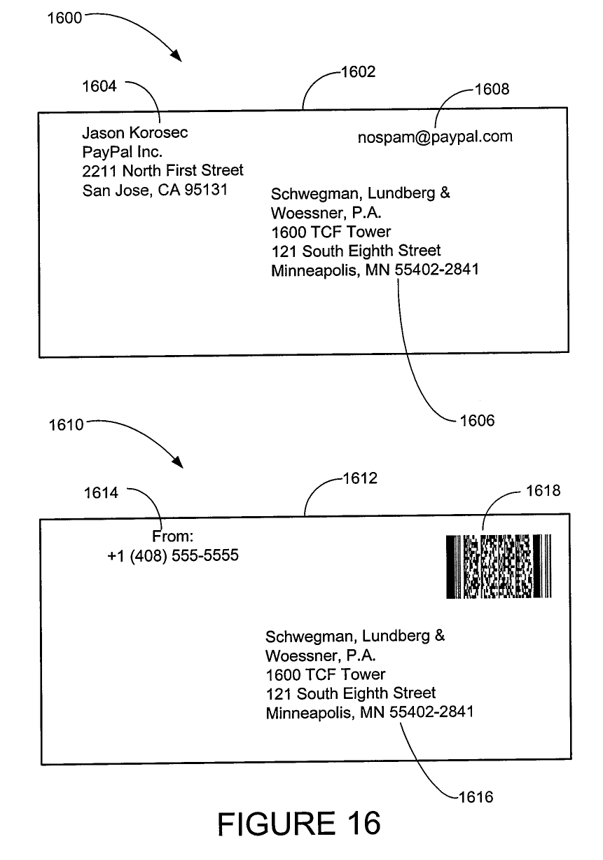

FIG. 16 illustrates example postal items 1600, 1610 according to an example embodiment. The postal items 1600, 1610 may be used by the system 100, the subsystems 110, 116, the methods 400-1500, or may be otherwise used.

The postal item 1600 includes a postal label 1602 with source user data 1604, recipient data 1606, and an electronic communication identifier 1608. The source user data 1604 is shown to include a source user name, a source user company name, a source user street address, a source user city, a source user state, and a source user zip code. The recipient data 1606 includes a recipient name, a recipient street address, a recipient city, a recipient state, and a recipient zip code. The electronic communication identifier 1608 is an e-mail address.

The postal item 1610 includes a postal label 1602 with source user data 1604, recipient data 1606, and an electronic communication identifier 1608. The source user data 1604 includes a source user phone number. The recipient data 1606 includes a recipient name, a recipient street address, a recipient city, a recipient state, and a recipient zip code. The electronic communication identifier 1608 is an e-mail address. The electronic communication identifier 1608 is in the form of a two-dimensional bar code.

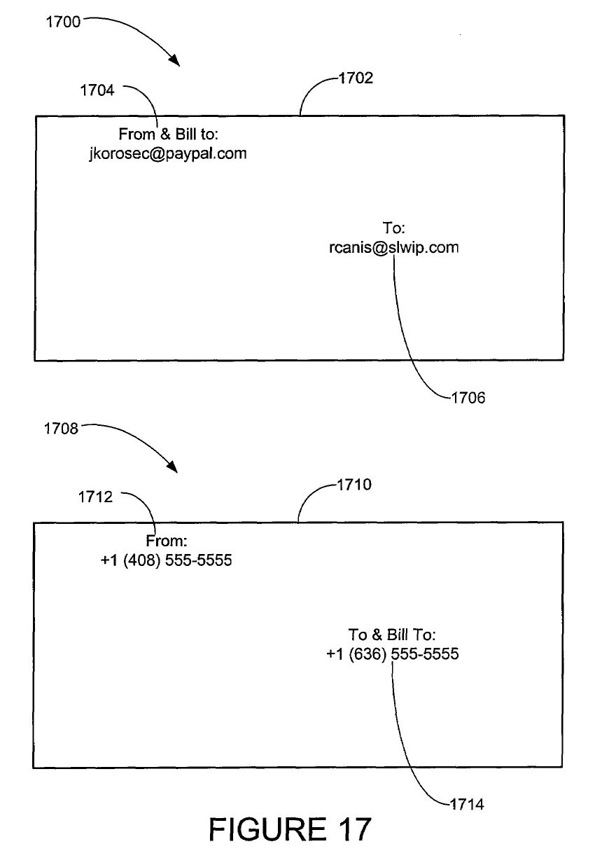

FIG. 17 illustrates example postal items 1700, 1708 according to an example embodiment. The postal items 1700, 1708 may be used by the system 100, the subsystems 110, 116, the methods 400-1500, or may be otherwise used.

The postal item 1700 includes a postal label 1702 with an electronic identifier 1704 and recipient data 1706. The electronic identifier 1704 includes an e-mail address and designation of payment by the source user. The recipient data 1706 includes an e-mail address.

The postal item 1708 includes a postal label 1710 with source user data 1712 and an electronic identifier 1714. The source user data 1712 includes a source user telephone number. The electronic identifier 1714 includes a recipient telephone number and designation of payment by the recipient.

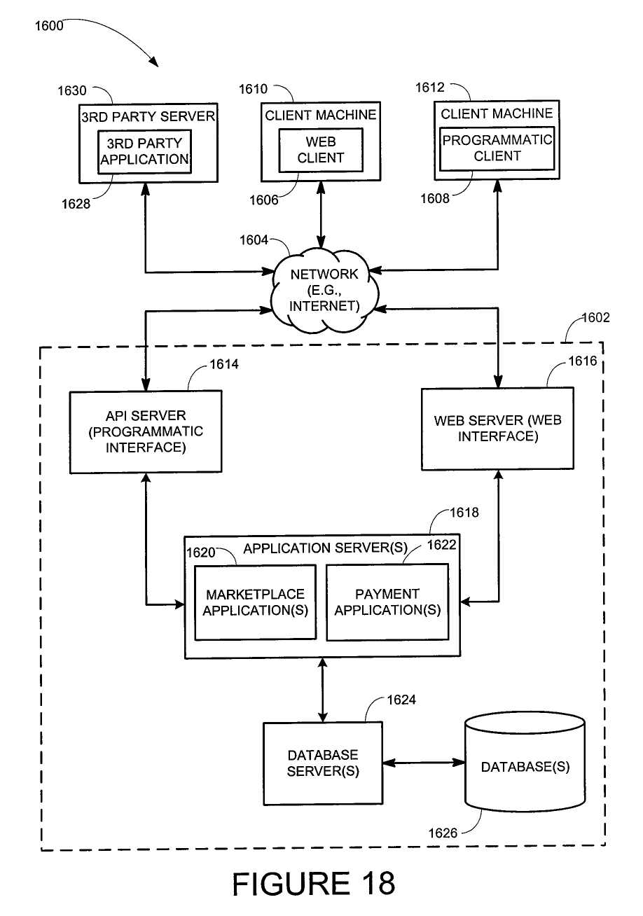

FIG. 18 is a network diagram depicting a client-server system 1800, within which one example embodiment may be deployed. By way of example, a network 1804 may include the functionality of the network 104, the verification provider 106, the postal item processor 108, and/or the payment processor 114 may be deployed within an application server 1818, and the client machine 102 may include the functionality of a client machine 1810 or a client machine 1812. The system 1800 may also be deployed in other systems.

A networked system 1802, in the example forms of a network-based marketplace or publication system, provides server-side functionality, via a network 1804 (e.g., the Internet or Wide Area Network (WAN)) to one or more clients. FIG. 18 illustrates, for example, a web client 1806 (e.g., a browser, such as the Internet Explorer browser developed by Microsoft Corporation of Redmond, Wash. State), and a programmatic client 1808 executing on respective client machines 1810 and 1812.

An Application Program Interface (API) server 1814 and a web server 1816 are coupled to, and provide programmatic and web interfaces respectively to, one or more application servers 1818. The application servers 1818 host one or more marketplace applications 1820 and authentication providers 1822. The application servers 1818 are, in turn, shown to be coupled to one or more databases servers 1824 that facilitate access to one or more databases 1826.

The marketplace applications 1820 may provide a number of marketplace functions and services to users that access the networked system 1802. The authentication providers 1822 may likewise provide a number of payment services and functions to users. The authentication providers 1822 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 1820. While the marketplace and authentication providers 1820 and 1822 are shown in FIG. 18 to both form part of the networked system 1802, in alternative embodiments the authentication providers 1822 may form part of a payment service that is separate and distinct from the networked system 1802.

Further, while the system 1800 shown in FIG. 18 employs a client-server architecture, embodiments of the present invention are of course not limited to such an architecture, and could equally well find application in a distributed, or peer-to-peer, architecture system, for example. The various marketplace and authentication providers 1820 and 1822 could also be implemented as standalone software programs, which need not have networking capabilities.

The web client 1806 accesses the various marketplace and authentication providers 1820 and 1822 via the web interface supported by the web server 1816. Similarly, the programmatic client 1808 accesses the various services and functions provided by the marketplace and authentication providers 1820 and 1822 via the programmatic interface provided by the API server 1814. The programmatic client 1808 may, for example, be a seller application (e.g., the TurboLister™ application developed by eBay Inc., of San Jose, Calif.) to enable sellers to author and manage listings on the networked system 1802 in an off-line manner, and to perform batch-mode communications between the programmatic client 1808 and the networked system 1802.

FIG. 18 also illustrates a third party application 1828, executing on a third party server machine 1830, as having programmatic access to the networked system 1802 via the programmatic interface provided by the API server 1814. For example, the third party application 1828 may, utilizing information retrieved from the networked system 1802, support one or more features or functions on a website hosted by the third party. The third party may, for example, provide one or more promotional, marketplace or payment functions that are supported by the relevant applications of the networked system 1802.

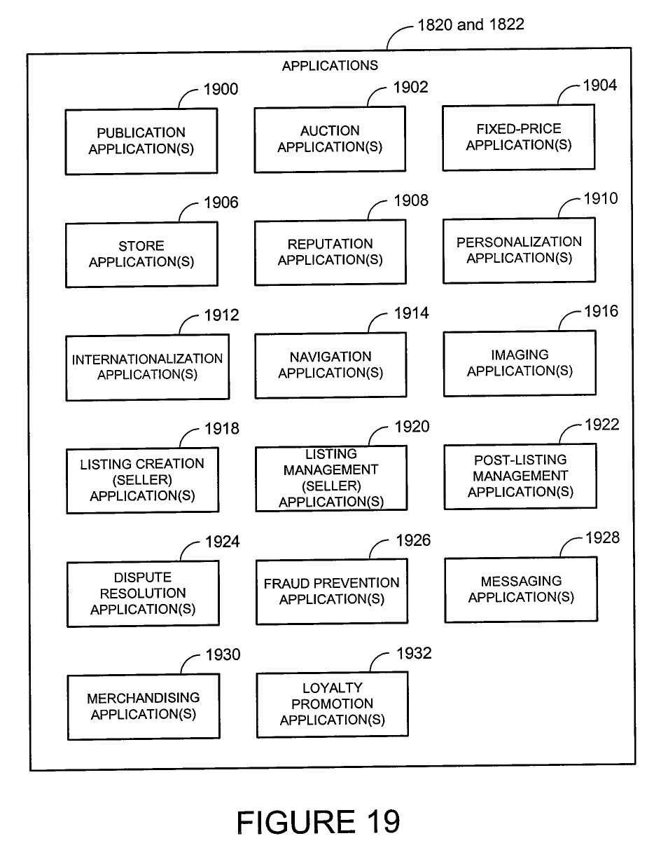

FIG. 19 is a block diagram illustrating multiple applications 1820 and 1822 that, in one example embodiment, are provided as part of the networked system 1802 (see FIG. 18). The applications 1820 may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access one or more databases 1826 via the database servers 1824.

The networked system 1802 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 1820 are shown to include at least one publication application 1900 and one or more auction applications 1902 which support auction-format listing and price setting mechanisms (e.g., English, Dutch, Vickrey, Chinese, Double, Reverse auctions etc.). The various auction applications 1902 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 1904 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 1906 allow a seller to group listings within a “virtual” store, which may be branded and otherwise personalized by and for the seller. Such a virtual store may also offer promotions, incentives and features that are specific and personalized to a relevant seller.

Reputation applications 1908 allow users that transact, utilizing the networked system 1802, to establish, build and maintain reputations, which may be made available and published to potential trading partners. Consider that where, for example, the networked system 1802 supports person-to-person trading, users may otherwise have no history or other reference information whereby the trustworthiness and credibility of potential trading partners may be assessed. The reputation applications 1908 allow a user, for example through feedback provided by other transaction partners, to establish a reputation within the networked system 1802 over time. Other potential trading partners may then reference such a reputation for the purposes of assessing credibility and trustworthiness.

Personalization applications 1910 allow users of the networked system 1802 to personalize various aspects of their interactions with the networked system 1802. For example a user may, utilizing an appropriate personalization application 1910, create a personalized reference page at which information regarding transactions to which the user is (or has been) a party may be viewed. Further, a personalization application 1910 may enable a user to personalize listings and other aspects of their interactions with the networked system 1802 and other parties.

The networked system 1802 may support a number of marketplaces that are customized, for example, for specific geographic regions. A version of the networked system 1802 may be customized for the United Kingdom, whereas another version of the networked system 1802 may be customized for the United States. Each of these versions may operate as an independent marketplace, or may be customized (or internationalized and/or localized) presentations of a common underlying marketplace. The networked system 1802 may accordingly include a number of internationalization applications 1912 that customize information (and/or the presentation of information) by the networked system 1802 according to predetermined criteria (e.g., geographic, demographic or marketplace criteria). For example, the internationalization applications 1912 may be used to support the customization of information for a number of regional websites that are operated by the networked system 1802 and that are accessible via respective web servers 1816.

Navigation of the networked system 1802 may be facilitated by one or more navigation applications 1914. For example, a search application (as an example of a navigation application) may enable key word searches of listings published via the networked system 1802. A browse application may allow users to browse various category, catalogue, or system inventory structures according to which listings may be classified within the networked system 1802. Various other navigation applications may be provided to supplement the search and browsing applications.

In order to make listings available via the networked system 1802 as visually informing and attractive as possible, the marketplace applications 1820 may include one or more imaging applications 1916 utilizing which users may upload images for inclusion within listings. An imaging application 1916 also operates to incorporate images within viewed listings. The imaging applications 1916 may also support one or more promotional features, such as image galleries that are presented to potential buyers. For example, sellers may pay an additional fee to have an image included within a gallery of images for promoted items.

Listing creation applications 1918 allow sellers conveniently to author listings pertaining to goods or services that they wish to transact via the networked system 1802, and listing management applications 1900 allow sellers to manage such listings. Specifically, where a particular seller has authored and/or published a large number of listings, the management of such listings may present a challenge. The listing management applications 1900 provide a number of features (e.g., auto-relisting, inventory level monitors, etc.) to assist the seller in managing such listings. One or more post-listing management applications 1902 also assist sellers with a number of activities that typically occur post-listing. For example, upon completion of an auction facilitated by one or more auction applications 1802, a seller may wish to leave feedback regarding a particular buyer. To this end, a post-listing management application 1902 may provide an interface to one or more reputation applications 1908, so as to allow the seller conveniently to provide feedback regarding multiple buyers to the reputation applications 1908.

Dispute resolution applications 1914 provide mechanisms whereby disputes arising between transacting parties may be resolved. For example, the dispute resolution applications 1914 may provide guided procedures whereby the parties are guided through a number of steps in an attempt to settle a dispute. In the event that the dispute cannot be settled via the guided procedures, the dispute may be escalated to a merchant mediator or arbitrator.

A number of fraud prevention applications 1926 implement fraud detection and prevention mechanisms to reduce the occurrence of fraud within the networked system 1802.

Messaging applications 1928 are responsible for the generation and delivery of messages to users of the networked system 1802, such messages for example advising users regarding the status of listings at the networked system 1802 (e.g., providing “outbid” notices to bidders during an auction process or to provide promotional and merchandising information to users). Respective messaging applications 1928 may utilize any one have a number of message delivery networks and platforms to deliver messages to users. For example, messaging applications 1928 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 1930 support various merchandising functions that are made available to sellers to enable sellers to increase sales via the networked system 1802. The merchandising applications 1930 also operate the various merchandising features that may be invoked by sellers, and may monitor and track the success of merchandising strategies employed by sellers.

The networked system 1802 itself, or one or more parties that transact via the networked system 1802, may operate loyalty programs that are supported by one or more loyalty/promotions applications 1932. For example, a buyer may earn loyalty or promotions points for each transaction established and/or concluded with a particular seller, and may be offered a reward for which accumulated loyalty points can be redeemed.

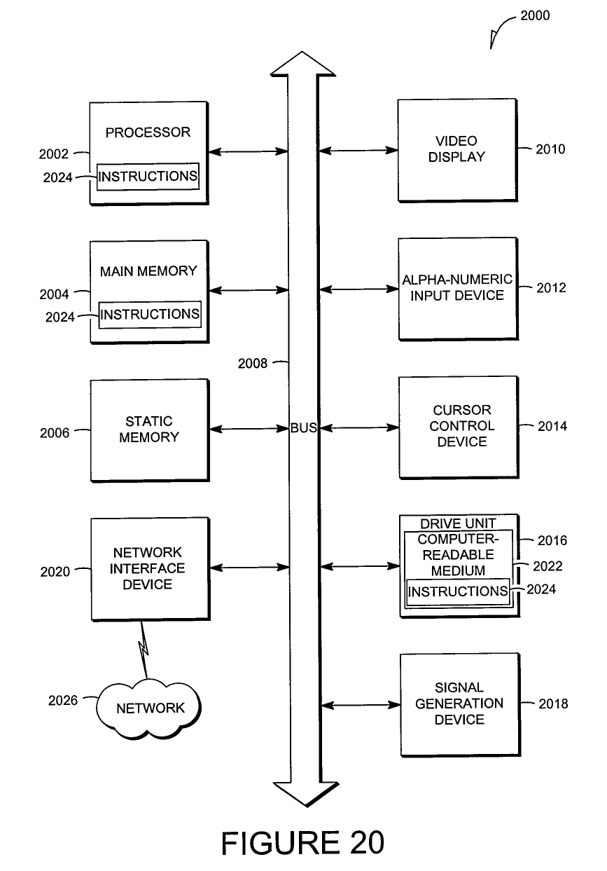

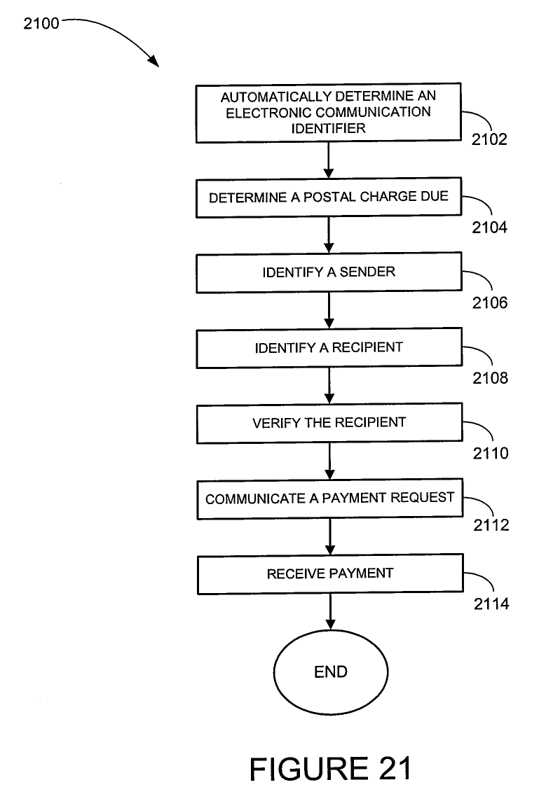

FIG. 20 shows a diagrammatic representation of machine in the example form of a computer system 2000 within which a set of instructions may be executed causing the machine to perform any one or more of the methods, processes, operations, or methodologies discussed herein. The verification provider 106, the postal item processor 108, and/or the payment provider 114 may operate on one or more computer systems 2000. The client machine 102 may include the functionality of the one or more computer systems 2000.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2000 includes a processor 2002 (e.g., a central processing unit (CPU) a graphics processing unit (GPU) or both), a main memory 2004 and a static memory 2006, which communicate with each other via a bus 2008. The computer system 2000 may further include a video display unit 2010 (e.g., a liquid crystal display (LCD) or a cathode ray tube (CRT)). The computer system 2000 also includes an alphanumeric input device 2012 (e.g., a keyboard), a cursor control device 2014 (e.g., a mouse), a drive unit 2016, a signal generation device 2018 (e.g., a speaker) and a network interface device 2020.

The drive unit 2016 includes a machine-readable medium 2022 on which is stored one or more sets of instructions (e.g., software 2024) embodying any one or more of the methodologies or functions described herein. The software 2024 may also reside, completely or at least partially, within the main memory 2004 and/or within the processor 2002 during execution thereof by the computer system 2000, the main memory 2004 and the processor 2002 also constituting machine-readable media.

The software 2024 may further be transmitted or received over a network 2026 via the network interface device 2020.

While the machine-readable medium 2022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

FIG. 21 illustrates a method 2100 for postal item processing according to an example embodiment. The method 2100 may be performed by the client machine 102, the verification provider 106, and/or the postal item processor 108 of the system 100 (see FIG. 1) or otherwise performed.

An electronic communication identifier associated with a postal item is automatically determined at block 2102. A postal charge due for delivery of the postal item by the postal item processor 108 is determined at block 2104. The electronic communication identifier may be associated with a sender of the postal item.

The sender of the postal item may be identified using the electronic application identifier at block 2106. A recipient of the postal item may be identified at block 2108. Verifying that the recipient is approved by the sender may be made at block 2110.

A payment request for the postal charge is communicated to the payment provider 114 at block 2112. The electronic communication identifier may be associated with an account of a user accessible by the payment provider 114. The payment request may include the electronic communication identifier.

At block 2114, payment may be received via the payment provider 114 of the postal charge from the user responsive to the payment request. The account of the user may be a funded account that is maintained by the payment provider 114.

Certain systems, apparatus, applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules be implemented as hardware circuitry, optical components, single or multi-processor circuits, memory circuits, software program modules and objects, firmware, and combinations thereof, as appropriate for particular implementations of various embodiments.

Thus, methods and systems for postal payments and addressing have been described. Although embodiments of the present invention have been described with reference to specific example embodiments, it will be evident that various modifications and changes may be made to these embodiments without departing from the broader spirit and scope of the embodiments of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby

What is claimed is:

1. A method comprising:
accessing an electronic communication identifier associated with a postal item;
accessing source user data associated with the postal item;
identifying a user associated with the electronic communication identifier;
verifying that the user is associated with the source user data; and
providing a confirmation of verification.

2. The method of claim 1, further comprising:
accessing user data from a database based on the electronic communication identifier,
wherein the identifying of the user and the verifying is performed using the user data.

3. The method of claim 1, further comprising:
accessing machine discernible data associated with the postal item; and
deriving the electronic communication identifier from the machine discernible data.

4. The method of claim 3, further comprising:
identifying a postage amount from the machine discernible data;
verifying the postage amount of the postal item; and
providing a postage amount match based on the verifying of the postage amount.

5. The method of claim 3, wherein the machine discernible data is single dimension bar code, a multidimensional bar code, or combinations thereof.

6. The method of claim 1, wherein the accessing of the electronic communication identifier comprises:
optically detecting the electronic communication identifier from the postal item.

7. The method of claim 1, wherein the accessing of the electronic communication identifier comprises:
detecting a radio frequency from the postal item, the radio frequency being associated with the electronic communication identifier.

8. The method of claim 1, further comprising:
scanning the postal item; and
identifying a presence of the electronic communication identifier on the postal item based on the scanning of the postal item.

10. The method of claim 1, further comprising:
accessing recipient data from the postal item;
verifying the recipient data meets a recipient criterion,
wherein the providing of the confirmation of verification is responsive to the verifying of the user and the verifying of the recipient data.

11. The method of claim 10, wherein the recipient data includes a recipient name, a recipient street address, a recipient city, a recipient state, a recipient zip code, a recipient country, a recipient phone number, a recipient e-mail address, or combinations thereof.

12. The method of claim 1, wherein the accessing of the electronic communication identifier comprises:
receiving the electronic communication identifier from a mail scanner device.

13. The method of claim 1, wherein the postal item is a post card, a letter, a telegram, a packages, overnight mail, or combinations thereof.

14. The method of claim 1, wherein the electronic communication identifier is an e-mail address, a mobile phone number, a postal account identifier, or combinations thereof.

15. The method of claim 1, wherein the source user data includes a source user name, a source user street address, a source user city, a source user state, a source user zip code, a source user country, a source user phone number, a source user e-mail address, or combinations thereof.

16. A method comprising:
accessing an electronic communication identifier associated with a postal item;
accessing source user data associated with the postal item;
identifying a user associated with the electronic communication identifier;
verifying that the user is associated with the source user data; and
processing the postal item for delivery based on the verifying of the user.

17. The method of claim 16, further comprising:
accessing machine discernible data associated with the postal item; and
deriving the electronic communication identifier from the machine discernible data.

18. The method of claim 17, further comprising:
identifying a postage amount paid from the machine discernible data;
determining a postage amount due for the postal item;
verifying that the postage amount paid satisfies the postage amount due;
wherein the processing of the postal item is based on the verifying of the user and the verifying of the postage amount paid.

19. The method of claim 18, further comprising:
providing a payment request to a payment provider based on an insufficient amount of the postage amount paid; and
receiving confirmation of payment from the payment provider,
wherein the processing of the postal item is based on the verifying of the user and the receiving of the confirmation.

20. The method of claim 18, further comprising:
providing a payment request to a payment provider based on an insufficient amount of the postage amount paid; and
receiving electronic payment of the insufficient amount from the payment provider,
wherein the processing of the postal item is based on the verifying of the user and the receiving of the electronic payment.

21. The method of claim 17, further comprising:
identifying a delivery priority rate from the machine discernible data,
wherein the processing of the postal item for delivery is based on the verifying of the user and the identifying of the delivery priority rate.

22. The method of claim 16, further comprising:
determining a postage amount due for the postal item;
providing a payment request for the postage amount due to a payment provider; and
receiving confirmation of payment from the payment provider,
wherein the processing of the postal item is based on the verifying of the user and the receiving of the confirmation.

23. The method of claim 22, further comprising:
determining whether the postage amount due satisfies a payment criterion associated with the user,
wherein the providing of the payment request is based on satisfaction of the payment criterion.

24. The method of claim 23, wherein the payment criterion is a payment minimum value, a payment maximum value, a predetermined user, a non-excluded user, an authorized reverse billing sender where the user-addressee pays the postage for the user-sender, or combinations thereof.

25. The method of claim 16, further comprising:
determining a postage amount due for the postal item;
providing a payment request for the postage amount due to a payment provider; and
receiving electronic payment in the postage amount due from the payment provider,
wherein the processing of the postal item is based on the verifying of the user and the receiving of the electronic payment.

26. The method of claim 16, further comprising:
determining a delivery priority rate based on the accessing of the electronic communication identifier,
wherein the processing of the postal item for delivery is based on the verifying of the user and the determining of the delivery priority rate.

27. A method comprising:
accessing an electronic communication identifier, source user data, and recipient data;
verifying that a user is associated with the source user data and the electronic communication identifier,
providing the electronic communication identifier for writing on a postal item, the electronic communication identifier associated with the user;
providing source user data for writing on the postal item, the source user data associated with the user; and
providing recipient data for writing on the postal item,
wherein the postal item is capable of being provided to a recipient associated with the recipient address after the writing of the electronic communication identifier, the source user data, and the recipient data on the postal item.

28. The method of claim 27, further comprising:
writing the electronic communication identifier, the source user data, and the recipient data on the postal item

29. The method of claim 27, further comprising:
providing the electronic communication identifier, the source user data, and the recipient data to a printing device, the printing device being capable of writing the electronic communication identifier, the source user data, and the recipient data on the postal item.

30. A method comprising:
accessing an electronic communication identifier associated with a postal item;
identifying a user associated with the electronic communication identifier;
verifying authorization of the user for use of the electronic communication identifier for postal item utilization; and
providing a confirmation of verification based on the verifying of the authorization.

31. The method of claim 30, further comprising:
accessing user data from a database based on the electronic communication identifier,
wherein the identifying of the user and the verifying is based on the user data.

32. The method of claim 30, further comprising:
accessing machine discernible data associated with the postal item; and
deriving the electronic communication identifier from the machine discernible data.

33. The method of claim 30, further comprising:
scanning the postal item;
identifying a presence of the electronic communication identifier on the postal item based on the scanning of the postal item,
wherein the accessing of the electronic communication identifier is based on the identifying of the presence.

34. The method of claim 30, wherein the user is a source user, a recipient, or combinations thereof.

35. A machine-readable medium comprising instructions, which when implemented by one or more processors perform the following operations:
access an electronic communication identifier associated with a postal item;
access source user data associated with the postal item;
identify a user associated with the electronic communication identifier;
verify that the user is associated with the source user data; and
provide a confirmation of verification.

36. The machine-readable medium of claim 35 further comprising instructions, which when implemented by one or more processors perform the following operations:
access machine discernible data associated with the postal item; and
derive the electronic communication identifier from the machine discernible data.

37. A machine-readable medium comprising instructions, which when implemented by one or more processors perform the following operations:
access an electronic communication identifier associated with a postal item;
access source user data associated with the postal item;
identify a user associated with the electronic communication identifier;
verify that the user is associated with the source user data; and
process the postal item for delivery based on verification of the user.

38. The machine-readable medium of claim 37 further comprising instructions, which when implemented by one or more processors perform the following operations:
determine a postage amount due for the postal item;
provide a payment request for the postage amount due to a payment provider; and
receive confirmation of payment from the payment provider,
wherein processing of the postal item is based on verification of the user and receipt of the confirmation.

39. A machine-readable medium comprising instructions, which when implemented by one or more processors perform the following operations:
accessing an electronic communication identifier associated with a postal item;
identifying a user associated with the electronic communication identifier;
verifying authorization of the user for use of the electronic communication identifier for postal item utilization; and
process the postal item for delivery based on verification of the authorization.

40. A system comprising:
an identifier access module to access an electronic communication identifier associated with a postal item;
a source user data access module to access source user data associated with the postal item;
a user identification module to identify a user associated with the electronic communication identifier accessed by the identifier access module;
a user verification module to verify that the user is associated with the source user data by the source user data access module; and
a confirmation provider module to provide a confirmation of verification by the user verification module.

41. The system of claim 40, further comprising:
a postal item scanner module to scan the postal item;
a presence identification module to identify a presence of the electronic communication identifier on the postal item based on the scanning of the postal item by the postal item scanner module,
wherein accessing of the electronic communication identifier by the identifier access module is based on identification of the presence by the presence identification module.

42. A method comprising:
automatically determining an electronic communication identifier associated with a postal item;
determining a postal charge due for delivery of the postal item by a postal item processor; and
communicating a payment request for the postal charge to a payment provider, the electronic communication identifier being associated with an account of a user accessible by the payment provider, and the payment request including the electronic communication identifier.

43. The method of claim 42, including receiving payment, via the payment provider, of the postal charge from the user responsive to the payment request.

44. The method of claim 42, wherein the account of the user is a funded account and is maintained by the payment provider.

45. The method of claim 42, wherein the electronic communication identifier is associated with a sender of the postal item, the method including identifying the sender of the postal item using the electronic application identifier, identifying a recipient of the postal item, and verifying that the recipient is approved by the sender.
